(19) United States
(12) Patent Application Publication
(10) Pub. No.: US 2025/0282383 A1
(43) Pub. Date: Sep. 11, 2025

(54) TOP VIEW REPRESENTATIONS FOR SENSOR FUSION APPLICATIONS

(71) Applicant: QUALCOMM Incorporated, San Diego, CA (US)

(72) Inventors: Thorbjoern Sven Jemander, Linköping (SE); Jacob Roll, Linköping (SE); Jonas Hammarstroem, Linköping (SE)

(21) Appl. No.: 18/596,202

(22) Filed: Mar. 5, 2024

(51) Int. Cl. B60W 60/00

(52) U.S. Cl. CPC B60W 60/0015; B60W 2556/35

(57) ABSTRACT

This disclosure provides systems, methods, and devices for vehicle driving assistance systems that support image processing. In a first aspect, a method is provided that includes a receiving sensor data from one or more sensors. The sensor data may be determined for an area surrounding a vehicle, and features may be determined based on the sensor data and projected into a top view representation of the area surrounding the vehicle. The top view representation may be defined by an inner contour and an outer contour. The inner contour may be determined based on an exterior contour of the vehicle, sensing capabilities of one or more sensors, or a combination thereof. Vehicle instructions may then be determined based on the features within the top view representation. Other aspects and features are also claimed and described.

### TECHNICAL FIELD

Aspects of the present disclosure relate generally to driver-operated or driver-assisted vehicles, and more particularly, to methods and systems suitable for supplying driving assistance or for autonomous driving.

### INTRODUCTION

Vehicles take many shapes and sizes, are propelled by a variety of propulsion techniques, and carry cargo including humans, animals, or objects. These machines have enabled the movement of cargo across long distances, movement of cargo at high speed, and movement of cargo that is larger than could be moved by human exertion. Vehicles originally were driven by humans to control speed and direction of the cargo to arrive at a destination. Human operation of vehicles has led to many unfortunate incidents resulting from the collision of vehicle with vehicle, vehicle with object, vehicle with human, or vehicle with animal. As research into vehicle automation has progressed, a variety of driving assistance systems have been produced and introduced. These include navigation directions by GPS, adaptive cruise control, lane change assistance, collision avoidance systems, night vision, parking assistance, and blind spot detection.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

Human operators of vehicles can be distracted, which is one factor in many vehicle crashes. Driver distractions can include changing the radio, observing an event outside the vehicle, and using an electronic device, etc. Sometimes circumstances create situations that even attentive drivers are unable to identify in time to prevent vehicular collisions. Aspects of this disclosure, provide improved systems for assisting drivers in vehicles with enhanced situational awareness when driving on a road.

In particular, aspects of this disclosure relate to sensor data processing for vehicles, specifically focusing on creating an efficient top view or birds-eye view (BEV) representation that minimizes computational resources and enhances the detection and processing of relevant environmental features. Techniques for shaping top view representations are described using amplitude modulation to better reflect the vehicle's form and/or sensor coverage, thus optimizing the area where features are detected and evaluated for vehicle control and monitoring.

One aspect provides a method that includes receiving, from one or more sensors, sensor data for an area surrounding a vehicle; determining, based on the sensor data, features within a top view representation of the area surrounding the vehicle, which includes (i) an outer contour defining an outer limit of the top view representation and (ii) an inner contour positioned within the outer contour, the inner contour defining an inner limit of the top view representation; and determining, based on the features within the top view representation, vehicle instructions for the vehicle.

Another aspect provides an apparatus that includes a memory storing processor-readable code and at least one processor coupled to the memory. The at least one processor may be configured to execute the processor-readable code to cause the at least one processor to perform operations, including receiving, from one or more sensors, sensor data for an area surrounding a vehicle; determining, based on the sensor data, features within a top view representation of the area surrounding the vehicle, which includes (i) an outer contour that defines an outer limit of the top view representation and (ii) an inner contour positioned within the outer contour, the inner contour defining an inner limit of the top view representation; and determining, based on the features within the top view representation, vehicle instructions for the vehicle.

A further aspect provides a non-transitory computer-readable medium storing instructions that, when executed by a processor, cause the processor to perform operations. The operations may include receiving, from a plurality of sensors, sensor data for an area surrounding a vehicle; determining, based on the sensor data, features within a top view representation of the area surrounding the vehicle, which includes (i) an outer contour that defines an outer limit of the top view representation and (ii) an inner contour positioned within the outer contour, the inner contour defining an inner limit of the top view representation; and determining, based on the features within the top view representation, vehicle instructions for the vehicle.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) ng networks, LTE networks, GSM networks, 5th Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). 5G networks include diverse deployments, diverse spectrum, and diverse services and devices that may be implemented using an OFDM-based unified, air interface.

The present disclosure may describe certain aspects with reference to LTE, 4G, or 5G NR technologies; however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHz-300 GHz) which is identified by the International Telecommunications Union (ITU) as a “mmWave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD or TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHz, subcarrier spacing may occur with 120 kHz over a 500 MHz bandwidth.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur.

Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

In the following description, numerous specific details are set forth, such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well known circuits and devices are shown in block diagram form to avoid obscuring teachings of the present disclosure.

Some portions of the detailed descriptions which follow are presented in terms of procedures, logic blocks, processing, and other symbolic representations of operations on data bits within a computer memory. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

In the figures, a single block may be described as performing a function or functions. The function or functions performed by that block may be performed in a single component or across multiple components, and/or may be performed using hardware, software, or a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory, and the like.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving,” “settling,” “generating” or the like, refer to the actions and processes of a computer system, or similar electronic computing device, that manipulates and transforms data represented as physical (electronic) quantities within the computer system's registers and memories into other data similarly represented as physical quantities within the computer system's registers, memories, or other such information storage, transmission, or display devices.

The terms “device” and “apparatus” are not limited to one or a specific number of physical objects (such as one smartphone, one camera controller, one processing system, and so on). As used herein, a device may be any electronic device with one or more parts that may implement at least some portions of the disclosure. For example, a device may include an electronic control unit of a vehicle. While the below description and examples use the term “device” to describe various aspects of the disclosure, the term “device” is not limited to a specific configuration, type, or number of objects. As used herein, an apparatus may include a device or a portion of the device for performing the described operations.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination.

Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof.

Also, as used herein, the term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

Also, as used herein, relative terms, unless otherwise specified, may be understood to be relative to a reference by a certain amount. For example, terms such as “higher” or “lower” or “more” or “less” may be understood as higher, lower, more, or less than a reference value by a threshold amount.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a perspective view of a motor vehicle according to embodiments of this disclosure.

FIG. 2 shows a block diagram of an example image processing configuration for a vehicle according to one or more aspects of the disclosure.

FIG. 3 is a block diagram illustrating details of an example wireless communication system according to one or more aspects.

FIG. 4 is a block diagram illustrating a system for determining top view representations according to one or more aspects of the disclosure.

FIG. 5 is a flow chart illustrating an example method for determining top view representations according to one or more aspects of the disclosure.

FIGS. 6A-6B depict top view representations according to various aspects of the present disclosure.

FIGS. 7A-7D and 8A-8D depict top view representations according to various aspects of the present disclosure.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure provides systems, apparatus, methods, and computer-readable media that support improved determination and definition of top view representations for vehicles. Existing techniques for sensor data analysis, such as sensor fusion, in vehicle applications may employ a top view to combine and analyze data from various sensors, such as cameras, radars, and lidars. These features may be projected into corresponding locations within the top view prior to subsequent analysis. These projections may be required to align with compute tensor's axes to maintain a computationally efficient mapping. This alignment results in significant portions of the grid being occupied by the vehicle itself-space that could be otherwise utilized for detecting pertinent features in the environment.

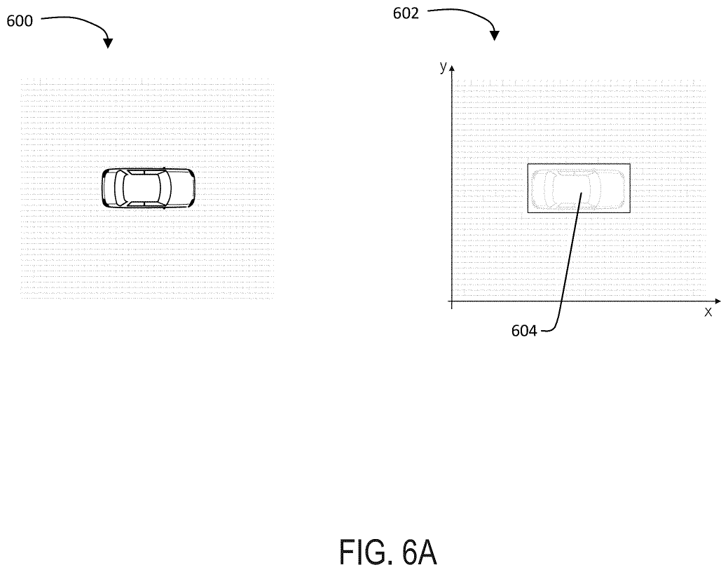

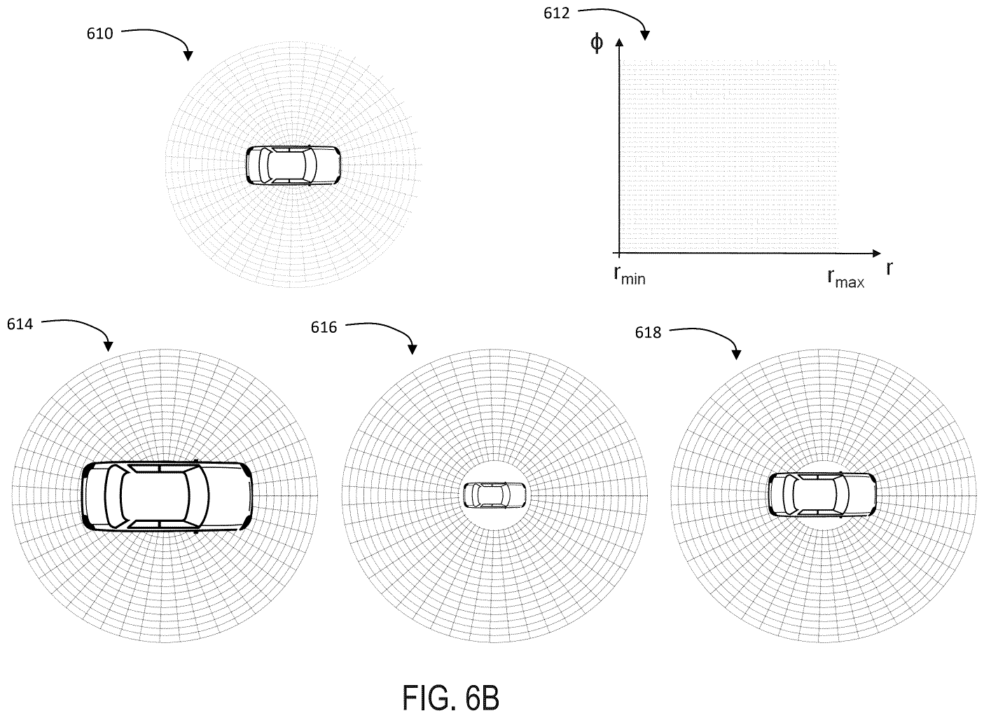

For example, top views may use Cartesian coordinates for these projections, such as the Cartesian coordinates in the top view representation 600 in FIG. 6A. However, when these coordinates are subsequently used to perform calculations or analysis, the corresponding projection (such as the projection 602) may have a gap (such as the gap 604) corresponding to the location of the vehicle. Thus, using Cartesian coordinates may reduce the computational efficiency of these models by relying on such non-utilized cells or coordinates in the top view representations.

Using polar coordinates may reduce the problem. For example, the top view representation 610 using polar coordinates may reduce the number of non-utilized cells or coordinates when compared to the top view representation 600. However, defining the size of the interior gap in polar representations results in trade-offs for computational efficiency. For example, the gap in the representation 614 may be smaller than the vehicle, which may improve coverage at the cost of additional wasted cells. As another example, the gap in the representation 616 is larger than the vehicle, which may improve computational efficiency at the cost of coverage. Other gap sizes, such as the gap in the representation 618 may represent compromised trade-offs between gap size, computational efficiency, and coverage.

One solution to this problem is to adjust the definitions of top view representations based on the vehicle, such as to match the shape of the vehicle, the shape of sensor coverage, or a combination thereof. The shape may be adjusted by varying the radius of the representation as a function of the angle, which may be referred to as amplitude modulation. Such adjustments may be defined using various techniques, such as sine/cosine series expansions or polynomial forms, to allow an arbitrary inner contour and/or outer contour to be used for the top view representation while maintaining a closed computational form. Contours for the top view representation may be selected based on the shape of the vehicle and/or the sensing capabilities of the vehicle's sensor suite. Additionally, cells within the top view representation may be flexibly defined using straight rays, non-centric rays, curved rays, non-contiguous rays, or a combination thereof. These techniques further allow for adjusting the outer contours of the top view representation to cater to asymmetric detection requirements and to having different grid densities, such as having a denser grid in the vehicle's front.

Particular implementations of the subject matter described in this disclosure may be implemented to realize one or more of the following potential advantages or benefits. In some aspects, the present disclosure provides techniques for optimizing sensor data processing grids for vehicles that may be particularly beneficial in reducing unnecessary computational overhead and enhancing the relevance and precision of environmental feature detection. For example, by sculpting the BEV grid to exclude the vehicle's own footprint and to match sensor coverage, the number of sensor data cells requiring analysis can be reduced. This reduction could potentially lead to decreased processing times and lower power consumption, which may be essential in battery-operated vehicles aiming to maximize efficiency. Additionally or alternatively, improving computational efficiency may enable the use of denser top view representations (such as smaller cells), which may improve the accuracy and/or precision of determined features.

Additionally, for end users, a more targeted and efficient grid system may result in more accurate vehicle instructions, potentially enhancing safety and the driving experience. This could be particularly noticeable in complex driving scenarios where sensor data must be rapidly and accurately interpreted. Overall, these techniques may also contribute to improved computer system performance by potentially requiring less memory for storing grid information and by possibly reducing the computational demand on onboard processors.

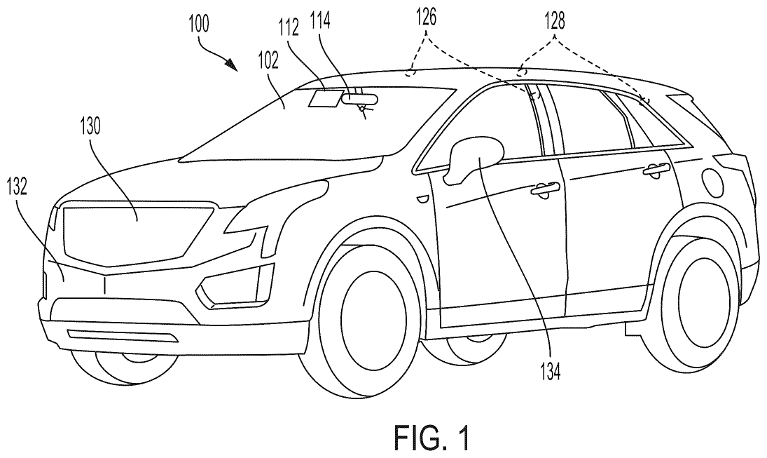

FIG. 1 is a perspective view of a motor vehicle with a driver monitoring system according to embodiments of this disclosure. A vehicle 100 may include a front-facing camera 112 mounted inside the cabin looking through the windshield 102. The vehicle may also include a cabin-facing camera 114 mounted inside the cabin looking towards occupants of the vehicle 100, and in particular the driver of the vehicle 100. Although one set of mounting positions for cameras 112 and 114 are shown for vehicle 100, other mounting locations may be used for the cameras 112 and 114. For example, one or more cameras may be mounted on one of the driver or passenger B pillars 126 or one of the driver or passenger C pillars 128, such as near the top of the pillars 126 or 128. As another example, one or more cameras may be mounted at the front of vehicle 100, such as behind the radiator grill 130 or integrated with bumper 132. As a further example, one or more cameras may be mounted as part of a driver or passenger side mirror assembly 134.

The camera 112 may be oriented such that the field of view of camera 112 captures a scene in front of the vehicle 100 in the direction that the vehicle 100 is moving when in drive mode or forward direction. In some embodiments, an additional camera may be located at the rear of the vehicle 100 and oriented such that the field of view of the additional camera captures a scene behind the vehicle 100 in the direction that the vehicle 100 is moving when in reverse direction. Although embodiments of the disclosure may be described with reference to a “front-facing” camera, referring to camera 112, aspects of the disclosure may be applied similarly to a “rear-facing” camera facing in the reverse direction of the vehicle 100. Thus, the benefits obtained while the operator is driving the vehicle 100 in a forward direction may likewise be obtained while the operator is driving the vehicle 100 in a reverse direction.

Further, although embodiments of the disclosure may be described with reference a “front-facing” camera, referring to camera 112, aspects of the disclosure may be applied similarly to an input received from an array of cameras mounted around the vehicle 100 to provide a larger field of view, which may be as large as 360 degrees around parallel to the ground and/or as large as 360 degrees around a vertical direction perpendicular to the ground. For example, additional cameras may be mounted around the outside of vehicle 100, such as on or integrated in the doors, on or integrated in the wheels, on or integrated in the bumpers, on or integrated in the hood, and/or on or integrated in the roof.

The camera 114 may be oriented such that the field of view of camera 114 captures a scene in the cabin of the vehicle and includes the user operator of the vehicle, and in particular the face of the user operator of the vehicle with sufficient detail to discern a gaze direction of the user operator.

Each of the cameras 112 and 114 may include one, two, or more image sensors, such as including a first image sensor. When multiple image sensors are present, the first image sensor may have a larger field of view (FOV) than the second image sensor or the first image sensor may have different sensitivity or different dynamic range than the second image sensor. In one example, the first image sensor may be a wide-angle image sensor, and the second image sensor may be a telephoto image sensor. In another example, the first sensor is configured to obtain an image through a first lens with a first optical axis and the second sensor is configured to obtain an image through a second lens with a second optical axis different from the first optical axis. Additionally or alternatively, the first lens may have a first magnification, and the second lens may have a second magnification different from the first magnification. This configuration may occur in a camera module with a lens cluster, in which the multiple image sensors and associated lenses are located in offset locations within the camera module. Additional image sensors may be included with larger, smaller, or same fields of view.

Each image sensor may include means for capturing data representative of a scene, such as image sensors (including charge-coupled devices (CCDs), Bayer-filter sensors, infrared (IR) detectors, ultraviolet (UV) detectors, complimentary metal-oxide-semiconductor (CMOS) sensors), and/or time of flight detectors. The apparatus may further include one or more means for accumulating and/or focusing light rays into the one or more image sensors (including simple lenses, compound lenses, spherical lenses, and non-spherical lenses). These components may be controlled to capture the first, second, and/or more image frames. The image frames may be processed to form a single output image frame, such as through a fusion operation, and that output image frame further processed according to the aspects described herein.

As used herein, image sensor may refer to the image sensor itself and any certain other components coupled to the image sensor used to generate an image frame for processing by the image signal processor or other logic circuitry or storage in memory, whether a short-term buffer or longer-term non-volatile memory. For example, an image sensor may include other components of a camera, including a shutter, buffer, or other readout circuitry for accessing individual pixels of an image sensor. The image sensor may further refer to an analog front end or other circuitry for converting analog signals to digital representations for the image frame that are provided to digital circuitry coupled to the image sensor.

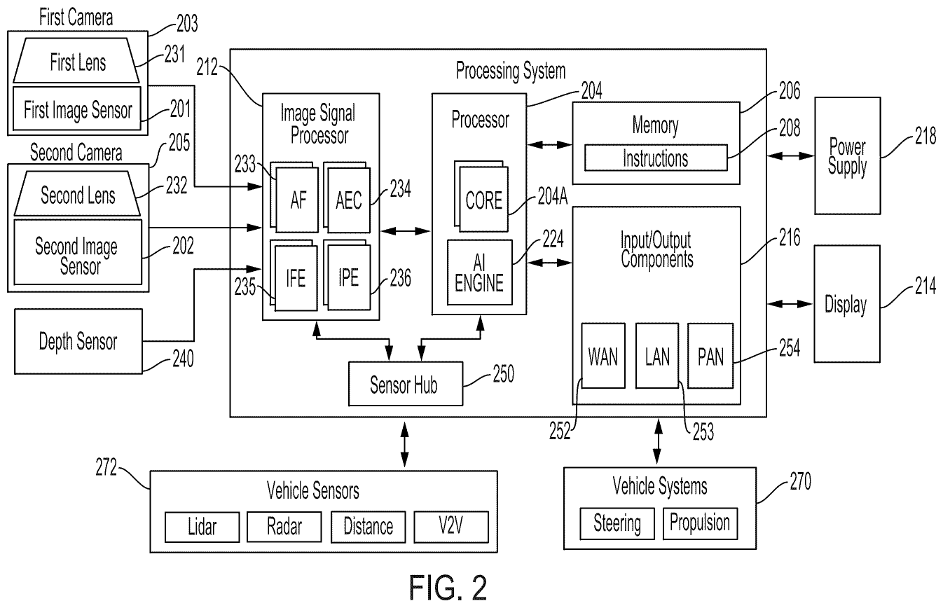

FIG. 2 shows a block diagram of an example image processing configuration for a vehicle according to one or more aspects of the disclosure. The vehicle 100 may include, or otherwise be coupled to, an image signal processor 212 for processing image frames from one or more image sensors, such as a first image sensor 201, a second image sensor 202, and a depth sensor 240. In some implementations, the vehicle 100 also includes or is coupled to a processor (e.g., CPU) 204 and a memory 206 storing instructions 208. The device 100 may also include or be coupled to a display 214 and input/output (I/O) components 216. I/O components 216 may be used for interacting with a user, such as a touch screen interface and/or physical buttons. I/O components 216 may also include network interfaces for communicating with other devices, such as other vehicles, an operator's mobile devices, and/or a remote monitoring system. The network interfaces may include one or more of a wide area network (WAN) adaptor 252, a local area network (LAN) adaptor 253, and/or a personal area network (PAN) adaptor 254. An example WAN adaptor 252 is a 4G LTE or a 5G NR wireless network adaptor. An example LAN adaptor 253 is an IEEE 802.11 WiFi wireless network adapter. An example PAN adaptor 254 is a Bluetooth wireless network adaptor. Each of the adaptors 252, 253, and/or 254 may be coupled to an antenna, including multiple antennas configured for primary and diversity reception and/or configured for receiving specific frequency bands. The vehicle 100 may further include or be coupled to a power supply 218, such as a battery or an alternator. The vehicle 100 may also include or be coupled to additional features or components that are not shown in FIG. 2. In one example, a wireless interface, which may include one or more transceivers and associated baseband processors, may be coupled to or included in WAN adaptor 252 for a wireless communication device. In a further example, an analog front end (AFE) to convert analog image frame data to digital image frame data may be coupled between the image sensors 201 and 202 and the image signal processor 212.

The vehicle 100 may include a sensor hub 250 for interfacing with sensors to receive data regarding movement of the vehicle 100, data regarding an environment around the vehicle 100, and/or other non-camera sensor data. One example non-camera sensor is a gyroscope, a device configured for measuring rotation, orientation, and/or angular velocity to generate motion data. Another example non-camera sensor is an accelerometer, a device configured for measuring acceleration, which may also be used to determine velocity and distance traveled by appropriately integrating the measured acceleration, and one or more of the acceleration, velocity, and or distance may be included in generated motion data. In further examples, a non-camera sensor may be a global positioning system (GPS) receiver, a light detection and ranging (LiDAR) system, a radio detection and ranging (RADAR) system, or other ranging systems. For example, the sensor hub 250 may interface to a vehicle bus for sending configuration commands and/or receiving information and sensor data from vehicle sensors 272, such as distance (e.g., ranging) sensors, radar sensors, lidar sensors, vehicle-to-vehicle (V2V) sensors (e.g., sensors for receiving information from nearby vehicles), or a combination thereof.

The image signal processor (ISP) 212 may receive image data, such as used to form image frames. In one embodiment, a local bus connection couples the image signal processor 212 to image sensors 201 and 202 of a first camera 203, which may correspond to camera 112 of FIG. 1, and second camera 205, which may correspond to camera 114 of FIG. 1, respectively. In another embodiment, a wire interface may couple the image signal processor 212 to an external image sensor. In a further embodiment, a wireless interface may couple the image signal processor 212 to the image sensor 201, 202.

The first camera 203 may include the first image sensor 201 and a corresponding first lens 231. The second camera 205 may include the second image sensor 202 and a corresponding second lens 232. Each of the lenses 231 and 232 may be controlled by an associated autofocus (AF) algorithm 233 executing in the ISP 212, which adjust the lenses 231 and 232 to focus on a particular focal plane at a certain scene depth from the image sensors 201 and 202. The AF algorithm 233 may be assisted by depth sensor 240. In some embodiments, the lenses 231 and 232 may have a fixed focus.

The first image sensor 201 and the second image sensor 202 are configured to capture one or more image frames. Lenses 231 and 232 focus light at the image sensors 201 and 202, respectively, through one or more apertures for receiving light, one or more shutters for blocking light when outside an exposure window, one or more color filter arrays (CFAs) for filtering light outside of specific frequency ranges, one or more analog front ends for converting analog measurements to digital information, and/or other suitable components for imaging.

In some embodiments, the image signal processor 212 may execute instructions from a memory, such as instructions 208 from the memory 206, instructions stored in a separate memory coupled to or included in the image signal processor 212, or instructions provided by the processor 204. In addition, or in the alternative, the image signal processor 212 may include specific hardware (such as one or more integrated circuits (ICs)) configured to perform one or more operations described in the present disclosure. For example, the image signal processor 212 may include one or more image front ends (IFEs) 235, one or more image post-processing engines (IPEs) 236, and or one or more auto exposure compensation (AEC) 234 engines. The AF 233, AEC 234, IFE 235, IPE 236 may each include application-specific circuitry, be embodied as software code executed by the ISP 212, and/or a combination of hardware within and software code executing on the ISP 212.

In some implementations, the memory 206 may include a non-transient or non-transitory computer readable medium storing computer-executable instructions 208 to perform all or a portion of one or more operations described in this disclosure. In some implementations, the instructions 208 include a camera application (or other suitable application) to be executed during operation of the vehicle 100 for generating images or videos. The instructions 208 may also include other applications or programs executed for the vehicle 100, such as an operating system, mapping applications, or entertainment applications. Execution of the camera application, such as by the processor 204, may cause the vehicle 100 to generate images using the image sensors 201 and 202 and the image signal processor 212. The memory 206 may also be accessed by the image signal processor 212 to store processed frames or may be accessed by the processor 204 to obtain the processed frames. In some embodiments, the vehicle 100 includes a system on chip (SoC) that incorporates the image signal processor 212, the processor 204, the sensor hub 250, the memory 206, and input/output components 216 into a single package.

In some embodiments, at least one of the image signal processor 212 or the processor 204 executes instructions to perform various operations described herein, including object detection, risk map generation, driver monitoring, and driver alert operations. For example, execution of the instructions can instruct the image signal processor 212 to begin or end capturing an image frame or a sequence of image frames. In some embodiments, the processor 204 may include one or more general-purpose processor cores 204A capable of executing scripts or instructions of one or more software programs, such as instructions 208 stored within the memory 206. For example, the processor 204 may include one or more application processors configured to execute the camera application (or other suitable application for generating images or video) stored in the memory 206.

In executing the camera application, the processor 204 may be configured to instruct the image signal processor 212 to perform one or more operations with reference to the image sensors 201 or 202. For example, the camera application may receive a command to begin a video preview display upon which a video comprising a sequence of image frames is captured and processed from one or more image sensors 201 or 202 and displayed on an informational display on display 114 in the cabin of the vehicle 100.

In some embodiments, the processor 204 may include ICs or other hardware (e.g., an artificial intelligence (AI) engine 224) in addition to the ability to execute software to cause the vehicle 100 to perform a number of functions or operations, such as the operations described herein. In some other embodiments, the vehicle 100 does not include the processor 204, such as when all of the described functionality is configured in the image signal processor 212.

In some embodiments, the display 214 may include one or more suitable displays or screens allowing for user interaction and/or to present items to the user, such as a preview of the image frames being captured by the image sensors 201 and 202. In some embodiments, the display 214 is a touch-sensitive display. The I/O components 216 may be or include any suitable mechanism, interface, or device to receive input (such as commands) from the user and to provide output to the user through the display 214. For example, the I/O components 216 may include (but are not limited to) a graphical user interface (GUI), a keyboard, a mouse, a microphone, speakers, a squeezable bezel, one or more buttons (such as a power button), a slider, a switch, and so on. In some embodiments involving autonomous driving, the I/O components 216 may include an interface to a vehicle's bus for providing commands and information to and receiving information from vehicle systems 270 including propulsion (e.g., commands to increase or decrease speed or apply brakes) and steering systems (e.g., commands to turn wheels, change a route, or change a final destination).

While shown to be coupled to each other via the processor 204, components (such as the processor 204, the memory 206, the image signal processor 212, the display 214, and the I/O components 216) may be coupled to each another in other various arrangements, such as via one or more local buses, which are not shown for simplicity. While the image signal processor 212 is illustrated as separate from the processor 204, the image signal processor 212 may be a core of a processor 204 that is an application processor unit (APU), included in a system on chip (SoC), or otherwise included with the processor 204. While the vehicle 100 is referred to in the examples herein for including aspects of the present disclosure, some device components may not be shown in FIG. 2 to prevent obscuring aspects of the present disclosure. Additionally, other components, numbers of components, or combinations of components may be included in a suitable vehicle for performing aspects of the present disclosure. As such, the present disclosure is not limited to a specific device or configuration of components, including the vehicle 100.

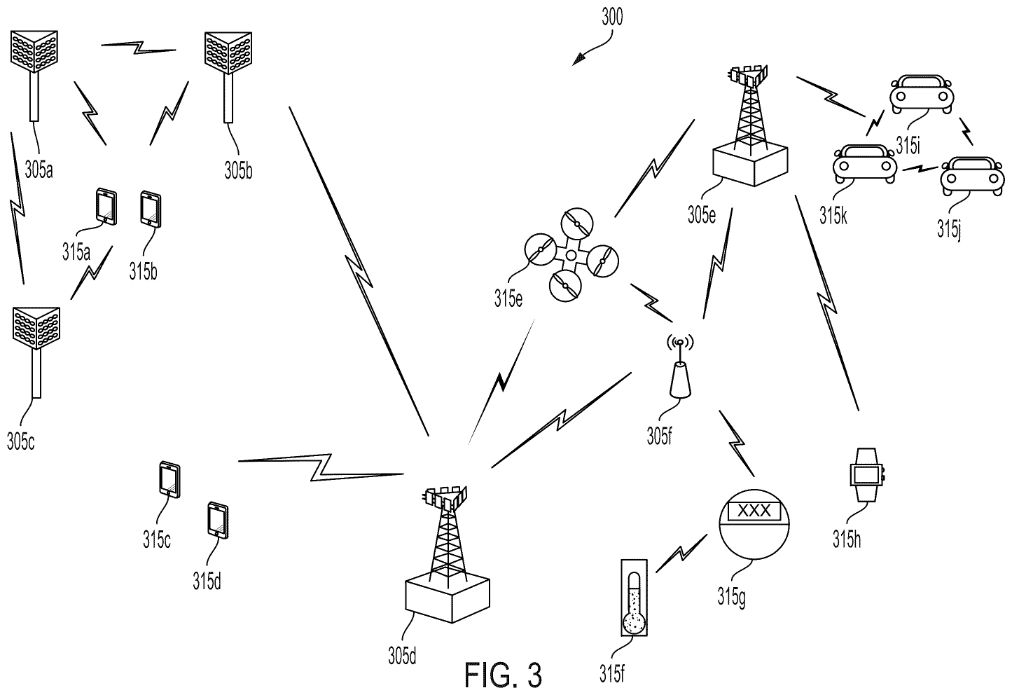

The vehicle 100 may communicate as a user equipment (UE) within a wireless network 300, such as through WAN adaptor 252, as shown in FIG. 3. FIG. 3 is a block diagram illustrating details of an example wireless communication system according to one or more aspects. Wireless network 300 may, for example, include a 5G wireless network. As appreciated by those skilled in the art, components appearing in FIG. 3 are likely to have related counterparts in other network arrangements including, for example, cellular-style network arrangements and non-cellular-style-network arrangements (e.g., device-to-device or peer-to-peer or ad-hoc network arrangements, etc.).

Wireless network 300 illustrated in FIG. 3 includes base stations 305 and other network entities. A base station may be a station that communicates with the UEs and may also be referred to as an evolved node B (eNB), a next generation eNB (gNB), an access point, and the like. Each base station 305 may provide communication coverage for a particular geographic area. In 3GPP, the term “cell” may refer to this particular geographic coverage area of a base station or a base station subsystem serving the coverage area, depending on the context in which the term is used. In implementations of wireless network 300 herein, base stations 305 may be associated with a same operator or different operators (e.g., wireless network 300 may include a plurality of operator wireless networks). Additionally, in implementations of wireless network 300 herein, base station 305 may provide wireless communications using one or more of the same frequencies (e.g., one or more frequency bands in licensed spectrum, unlicensed spectrum, or a combination thereof) as a neighboring cell. In some examples, an individual base station 305 or UE 315 may be operated by more than one network operating entity. In some other examples, each base station 305 and UE 315 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 3, base stations 305d and 305e are regular macro base stations, while base stations 305a-305c are macro base stations enabled with one of three-dimension (3D), full dimension (FD), or massive MIMO. Base stations 305a-305c take advantage of their higher dimension MIMO capabilities to exploit 3D beamforming in both elevation and azimuth beamforming to increase coverage and capacity. Base station 305f is a small cell base station which may be a home node or portable access point. A base station may support one or multiple (e.g., two, three, four, and the like) cells.

Wireless network 300 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 315 are dispersed throughout the wireless network 300, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology.

Some non-limiting examples of a mobile apparatus, such as may include implementations of one or more of UEs 315, include a mobile, a cellular (cell) phone, a smart phone, a session initiation protocol (SIP) phone, a wireless local loop (WLL) station, a laptop, a personal computer (PC), a notebook, a netbook, a smart book, a tablet, a personal digital assistant (PDA), and a vehicle. Although UEs 315a-j are specifically shown as vehicles, a vehicle may employ the communication configuration described with reference to any of the UEs 315a-315k.

In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 315a-315d of the implementation illustrated in FIG. 3 are examples of mobile smart phone-type devices accessing wireless network 300. A UE may also be a machine specifically configured for connected communication, including machine type communication (MTC), enhanced MTC (eMTC), narrowband IoT (NB-IoT) and the like. UEs 315e-315k illustrated in FIG. 3 are examples of various machines configured for communication that access wireless network 300.

A mobile apparatus, such as UEs 315, may be able to communicate with any type of the base stations, whether macro base stations, pico base stations, femto base stations, relays, and the like. In FIG. 3, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 300 may occur using wired or wireless communication links.

In operation at wireless network 300, base stations 305a-305c serve UEs 315a and 315b using 3D beamforming and coordinated spatial techniques, such as coordinated multipoint (CoMP) or multi-connectivity. Macro base station 305d performs backhaul communications with base stations 305a-305c, as well as small cell, base station 305f. Macro base station 305d also transmits multicast services which are subscribed to and received by UEs 315c and 315d. Such multicast services may include mobile television or stream video, or may include other services for providing community information, such as weather emergencies or alerts, such as Amber alerts or gray alerts.

Wireless network 300 of implementations supports mission critical communications with ultra-reliable and redundant links for mission critical devices, such UE 315e, which is a drone. Redundant communication links with UE 315e include from macro base stations 305d and 305e, as well as small cell base station 305f. Other machine type devices, such as UE 315f (thermometer), UE 315g (smart meter), and UE 315h (wearable device) may communicate through wireless network 300 either directly with base stations, such as small cell base station 305f, and macro base station 305e, or in multi-hop configurations by communicating with another user device which relays its information to the network, such as UE 315f communicating temperature measurement information to the smart meter, UE 315g, which is then reported to the network through small cell base station 305f. Wireless network 300 may also provide additional network efficiency through dynamic, low-latency TDD communications or low-latency FDD communications, such as in a vehicle-to-vehicle (V2V) mesh network between UEs 315i-315k communicating with macro base station 305e.

Aspects of the vehicular systems described with reference to, and shown in, FIG. 1, FIG. 2, and FIG. 3 may include dynamic or responsive determination of top view representations to improve computational efficiency.

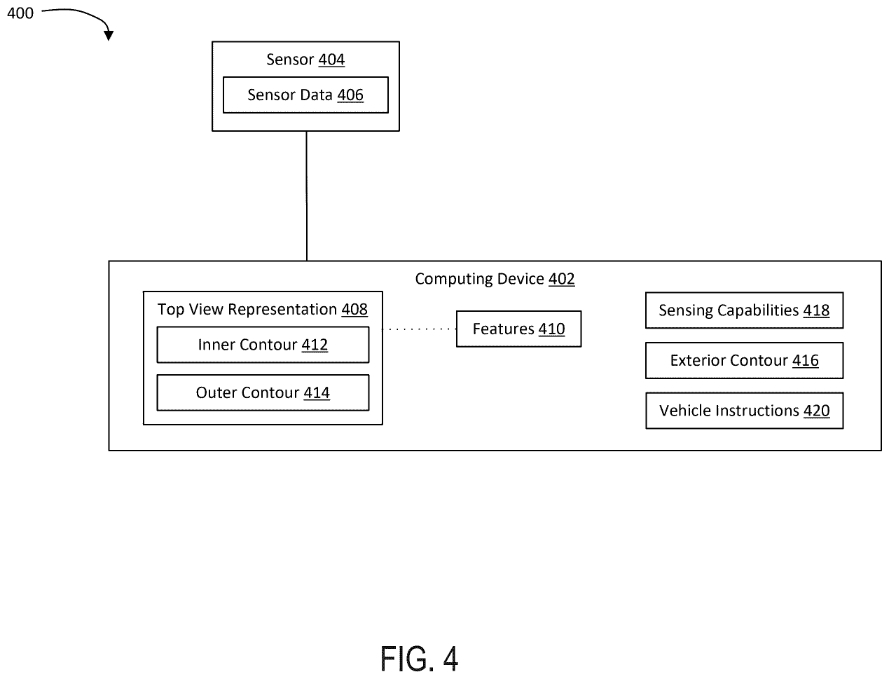

FIG. 4 is a block diagram illustrating a system 400 for determine features within improved top view representations according to one aspect of the present disclosure. The system 400 includes one or more sensors 404 and a computing device 402. The sensors 404 may be configured to capture sensor data 406, and to provide the sensor data 406 to the computing device 402 for further processing (such as to determine vehicle instructions 420) for a vehicle containing the computing device 402 and the sensors 404. Accordingly, the computing device 402 includes a top view representation 408, features 410, sensing capabilities 418, an exterior contour 416, and the vehicle instructions 420. The top view representation 408 includes an inner contour 412 and an outer contour 414. The system 400 may be an exemplary implementation of one or more above-discussed aspects. For example, the system 400 may be contained within the vehicle 100, may be an exemplary implementation of the processing system in FIG. 2 (such as the ISP 212, the processor 204, or combinations thereof), and the like.

The computing device 402 may be configured to receive, from the sensors 404, sensor data 406 for an area surrounding a vehicle. In certain implementations, the sensor data 406 may include image data captured by cameras, positioning information from GPS, radar data that provides detailed distance measurements, LIDAR data that provides detailed distance measurements, inertial measurements from IMUs (Inertial Measurement Units), and other data types that contribute to a comprehensive understanding of the vehicle's environment.

The computing device 402 may be configured to determine, based on the sensor data 406, features 410 within a top view representation 408 of the area surrounding the vehicle. A top view representation, in the context of vehicle applications such as autonomous vehicle navigation and perception systems, may be understood as a two-dimensional depiction of the environment surrounding a vehicle, as it would be perceived from a hypothetical vantage point directly above the vehicle (such as a bird's eye view (BEV)). Such representations may be generated to provide a comprehensive overview of the vehicle's immediate surroundings, which may prove invaluable in safe navigation and driving strategy formulation.

To generate a detailed and accurate top view representation, features from the sensor data 406 are often projected onto locations within the top view representation 408. This may include transforming spatial information for determined features into the top-down perspective of the top view.

The features 410 may include one or more feature vectors may be initially determined for received sensor data from various onboard sensors. For example, the features 410 may be features used by a perception pipeline for the vehicle. For example, the computing device 402 may be configured to receive image sensor data from one or more image sensors located on the vehicle and position sensor data from one or more position sensors located on the vehicle and may determine locations of objects within the area surrounding the vehicle based on the sensor data.

In certain implementations, features for image data may include numerical representations of various aspects of an image frame. Some examples of features include color histograms, texture descriptors, edge detection, and shape analysis. Color histograms may quantify the distribution of colors in an image, while texture descriptors may capture patterns such as roughness or smoothness. Edge detections may identify boundaries between objects in an image, while shape analysis may identify or otherwise distinguish different types of objects based on geometric properties of the object within the image frame. In certain implementations, features for position data may include numerical representations of various aspects of a point cloud. Some examples of features include distance histograms, surface normals, curvature estimation, and segmentation. Distance histograms may quantify the distribution of distances between points in a point cloud, while surface normals may capture the orientation of local surfaces. Curvature estimation may measure the degree of bending or flatness of a surface, while segmentation may identify or otherwise distinguish different types of objects based on spatial proximity and similarity of the points within the point cloud. In certain implementations, the features may be stored in feature vectors. The feature vectors may be single-dimensional, such as an N×1 vector, where N may be the number of features. In additional or alternative implementations, feature vectors may be multi-dimensional, such as an N×M×O tensor, where at least two of N, M, and O are greater than 1.

Features from the feature vectors may then be projected onto a top view representation, with each feature vector yielding a corresponding projection within the environment's top-down view. For example, the corresponding locations within the top view representation 408 may be determined based on the position, size, and orientation of certain features, as well as based on known orientations of the sensors 404 relative to the vehicle (such as which portions of the physical area are covered by particular sensors 404). In certain implementations, the features 410 may be computed by one or more machine learning models, such as one or more transformer models.

The top view representation 408 may be configured to support features for a particular portion of the area surrounding the vehicle. For example, the top view representation 408 may define the area for which features are determined that are subsequently used to determine vehicle instructions 420. In certain implementations, the top view representation 408 may include the inner contour 412 and the outer contour 414. The outer contour 414 may define an outer limit of the top view representation 408 and the inner contour 412 may define an inner limit of the top view representation 408. In such implementations, the inner contour 412 may define a portion of the area surrounding the vehicle that is within the outer contour 414, but for which features 410 are not determined. In certain implementations, the inner contour 412 may be defined to exclude a portion of the area that contains the vehicle from the top view representation 408.

In certain implementations, the inner contour 412 may be determined to remove, reduce, or eliminate regions within the area surrounding the vehicle that cannot be used in evaluating conditions (such as driving conditions) surrounding the vehicle. For example, such regions may include locations that correspond to the vehicle itself, locations that are outside of sensor range for the sensors 404, and the like. In certain implementations, the inner contour 412 may be centered at the location of the vehicle. In such instances, a radius of the inner contour 412 may vary as a function of an angle relative to the heading of the vehicle. The inner contour 412 might follow a parametric definition where its radius at any given angle θ from the vehicle's heading is determined by function, such as:

r=f(φ)

where r is the radius for a given angle φ. In certain implementations, the function may be determined as a series expansion, such as:

$$r ( φ ) = {\sum }_{k}^{N} {a}_{k} \cdot sin ( φ k + {b}_{k} )$$

where a₁ and bᵢ are coefficients of the expansion and N is the number of terms in the expansion. Similar techniques may be used to define both the inner contour 412 and the outer contour 414. For example, the outer contour 414 may vary as a function of an angle relative to the heading of the vehicle. The outer contour 414 may vary using a similar function and/or a different function as the inner contour. Such definitions may allow for customizable and response shapes of the contours 412, 414 while maintaining a closed form for computational efficiency.

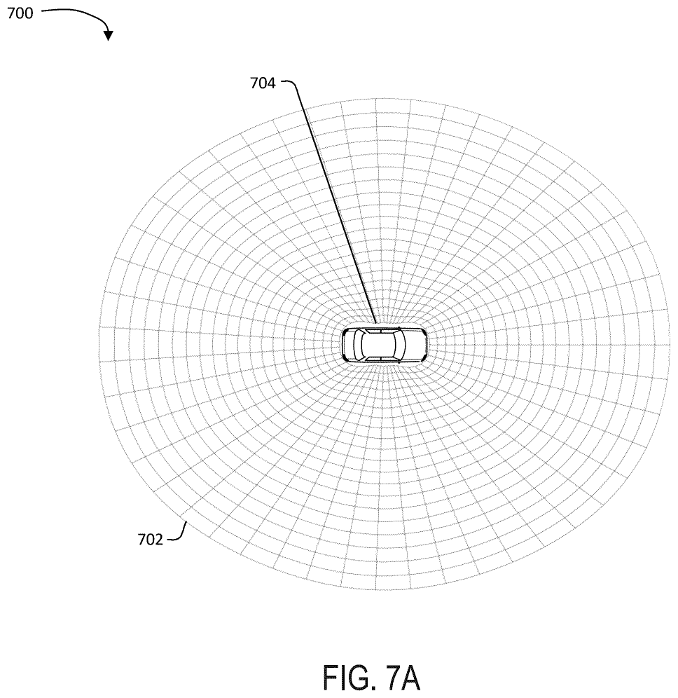

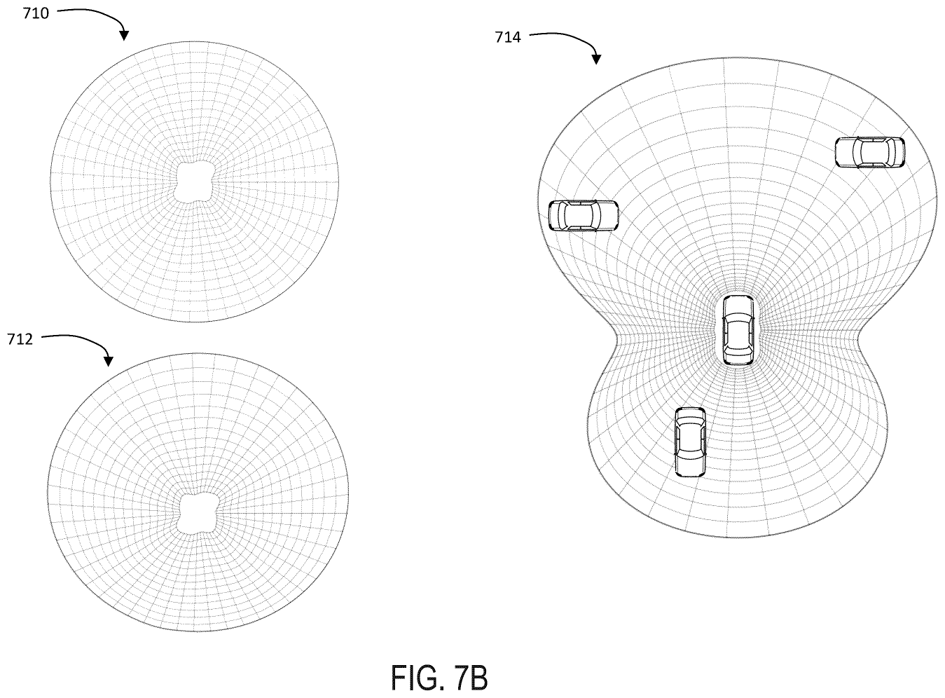

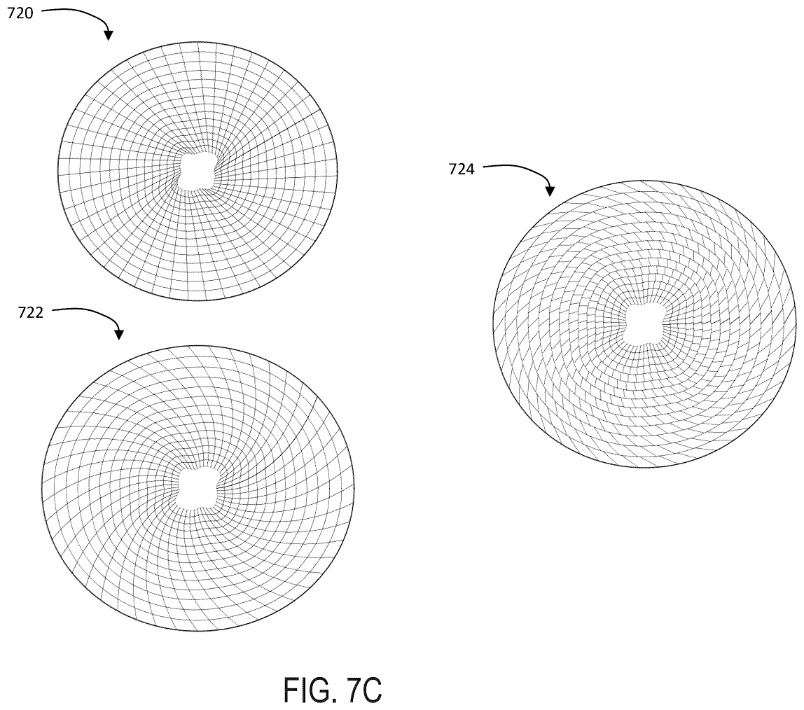

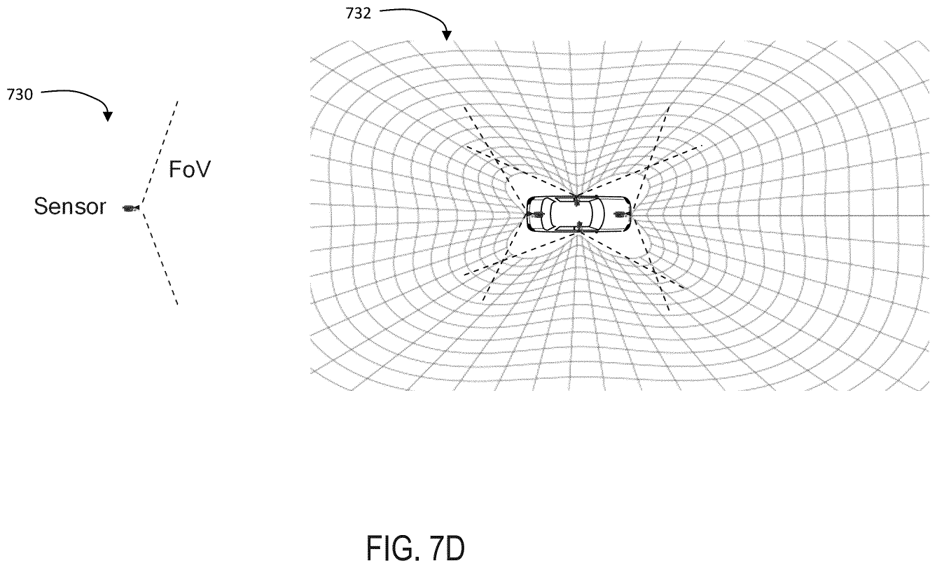

For example, FIG. 7A depicts a top view representation 700 that includes an outer contour 702 and an inner contour 704. The top view representation 700 may be an exemplary implementation of the top view representation 408. As can be seen in FIG. 7A, the inner contour 704 may be determined to exclude portions of the depicted area that include the vehicle itself. For example, in certain implementations, the computing device 402 may include, store, or otherwise access an exterior contour 416 of a corresponding vehicle. In such instances, the computing device 402 may determine the inner contour 412 of the top view representation 408 based on the exterior contour 416. In particular, the inner contour 412 may be determined as a top-down projection of the exterior contour 416 of the vehicle. In certain implementations, the exterior contour 416 may be specific to a particular make and model of vehicle. In additional or alternative implementations, the exterior contour 416 may be specific to a particular type of vehicle (such as a compact sedan, a midsize SUV, a pickup truck, and the like).

In certain implementations, the inner contour 412 may be defined based on sensing capabilities 418 for at least a subset of the plurality of sensors 404. In particular, the computing device 402 may include, store, or otherwise access sensing capabilities 418 for the vehicle. The sensing capabilities 418 may include the number and types of sensors 404 installed, such as cameras, LIDAR, radar, ultrasound, and GPS units, as well as their specific locations on the vehicle. Each sensor's individual capabilities can be described in detail, accounting for the sensor's operational range, field of view, resolution, accuracy, latency, responsiveness to varying environmental conditions, or a combination thereof. These capabilities allow for tailored adjustments to the top view representation 408 based on the individual and/or collective coverage of the area surrounding the vehicle by the sensors 404, reducing inefficiencies by excluding areas that are not covered from the top view representation 408. Furthermore, the sensing capabilities 418 can vary under different operating conditions, such as weather changes that may affect sensor performance. For example, the effective operating range of a LIDAR sensor might be reduced in heavy rain, necessitating adjustments to the size of the top view representation 408, which may enable adjusted processing of the sensor data in such conditions. In certain implementations, the sensing capabilities 418 may include sensing capabilities for an individual vehicle, a particular make and model of a vehicle, a particular type of vehicle, or combinations thereof.

As one particular example, FIG. 7D depicts sensing capabilities 730 for individual sensors (such as individual image sensors) located on a vehicle. A corresponding type of representation 732 is also depicted that is determined based on the sensing capabilities 730 of the four sensors located on the depicted vehicle. As can be seen in FIG. 7D, the inner contour of the top view representation 732 is further adjusted to exclude portions of blind spots within the area surrounding the vehicle for the sensors located on the vehicle. In particular, due to field of view restrictions indicated by the sensing capabilities 730, the field of view of the four sensors located on the vehicle may not cover the entire area surrounding the vehicle, resulting in blind spots located near the vehicle. The corresponding inner contour of the top view representation 732 is accordingly determined to exclude portions of these blind spots. In certain implementations, the computing device 402 may be configured to determine a parameterized curve (such as a parameterized curve of the form discussed above.for the inner contour 412 based on the sensing capabilities (such as based on a shape of blind spots for the sensors 404 determined based on the sensing capabilities 418).

In certain implementations, the outer contour 414 may be predetermined and consistent during operation of the vehicle. In additional or alternative implementations, the outer contour 414 may change in different operating conditions (such as for different operating speeds, different weather conditions, and the like). For instance, different models, different top view representations, or combinations thereof may be used to determine vehicle instructions 420 in different operating conditions. For example, a first model may be used for low-speed operation of a vehicle (such as 30 MPH or less) that has a top view representation with an outer contour of the first size, and a second model may be used for higher-speed operation of the vehicle (such as greater than 30 MPH) that has a top view representation with an outer contour of the second size greater than the first size. As another example, a smaller top view representation (and a slower operating speed) may be used in rainy conditions when a maximum sensor range may be limited.

In certain implementations, the outer contour 414 may be determined as a circular, elliptical, or other shaped regions with a predetermined radius/radii such as the outer contour 702 in FIG. 7A. In additional or alternative implementations, the outer contour 414 may be determined based on sensing capabilities 418 of at least a subset of the plurality of sensors 404. In certain implementations, the outer contour 414 may be determined to include all or part of an effective sensing range for a vehicle, or the effective sensing range is formed from the combined sensor coverage for all or a subset of the sensors coupled to a vehicle. For example, the outer contour 414 may be determined as a smooth curve that encompasses the sensing range for the vehicle. In certain implementations, the outer contour 414 may be circular in shape with a radius determined based on sensing capabilities 418 for at least one of the plurality of sensors 404 (such as the shortest range for one of the sensors 404, a maximum range for one of the sensors 404, an average range for one of the sensors 404, and the like).

In certain implementations, the inner contour 412 may be centered within the outer contour 414. For example, FIG. 7B depicts a top view representation 710 in which the inner contour is centered relative to the outer contour. In additional or alternative implementations, the inner contour 412 may be off-center relative to the outer contour 414. For example, FIG. 7B depicts a top view representation 712 in which the inner contour is off-center relative to the outer contour. In certain implementations, the radius of the outer contour may differ with the angle relative to the heading of the vehicle. For example, the top view representation 714 in FIG. 7B has an outer contour with a larger radius in front of the vehicle (such as to enable more feature vector cells and greater coverage for obstacles located in front of a vehicle) and a narrower radius on the sides of the vehicle (such as to enable smaller cells and more detail in lateral areas surrounding the vehicle.

In certain implementations, the top view representation 408 may further include cells extending between the inner contour 412 and the outer contour 414. In particular, the computing device 402 may be configured to determine features 410 that include feature vectors projected onto at least a subset of the cells. For example, each cell within the top view representation may have a corresponding feature vector within the features 410. In certain implementations, the cells may be arranged concentrically out from the inner contour to the outer contour, such as the cells depicted in the top view representation 710 of FIG. 7B. In additional or alternative implementations, the cells may be concentric, but formed from angled rays, such as the cells depicted in the top view representation 720 of FIG. 7C. In further implementations, the rays forming the cells may curve outward, such as the cells depicted in the top view representation 730 of FIG. 7C. In still further implementations, the cells may be non-contiguous, or staggered, such as the cells in the top view representation 724 of FIG. 7C. In certain implementations, the density of cells may differ with the angle relative to the heading of the vehicle. For example, the top view representation 408 may be formed to include a higher cell density and smaller cells in regions in front of the vehicle than in regions behind the vehicle.

In certain implementations, the computing device 402 may be configured to determine, based on the features 410 within the top view representation 408, vehicle instructions 420 for the vehicle. In certain implementations, vehicle instructions 420 may refer to the set of commands and guidelines that directly or indirectly regulate the movement of a vehicle. These instructions may come in the form of direct vehicular control instructions, such as steering, braking, accelerating or combinations thereof. In additional or alternative implementations, vehicle instructions may be supplementary instructions that support driver assistance programs, such as obstacle avoidance, blind spot monitoring, and other driver assistance alerts. In still further implementations, vehicle instructions may include instructions to present feedback to one or more occupants of the vehicle, such as visual feedback, auditory feedback, tactile feedback, or a combination thereof. In such instances, the feedback may be presented to an operator of the vehicle, an owner of the vehicle, a passenger of the vehicle, another individual, or a combination thereof. Vehicle instructions may accordingly help drivers to maintain safe operation of vehicles while driving on roads and highways.

In certain implementations, the computing device 402 may be configured to identify and project the features 410 within the top view representation 408 based on the received sensor data 406 (such as utilizing a first machine learning model). These projected features, such as a set of feature vectors corresponding to the cells in the top-down representation, may then be provided to one or more machine learning models, which may be separate from the first machine learning model, which may be trained to interpret the aggregate data and synthesize it into vehicle instructions.

In certain implementations, the top view representation 408 may be dynamically updated to improve performance and/or to adapt to new conditions. Such updates may be transmitted to the vehicle (such as over-the-air) and may be deployed within the computing device 402. In certain implementations, updates to the top view representation 408 may include updates to one or more models configured to receive features projected onto the top view representation 408. Such adaptability may ensure that the system evolves to maintain optimal functionality, even as environmental conditions or sensor characteristics change over time.

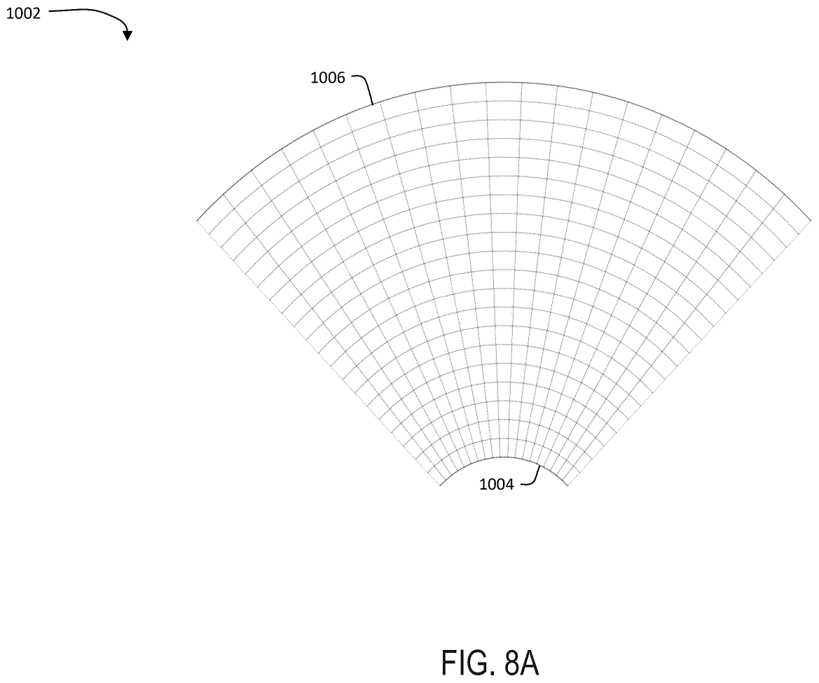

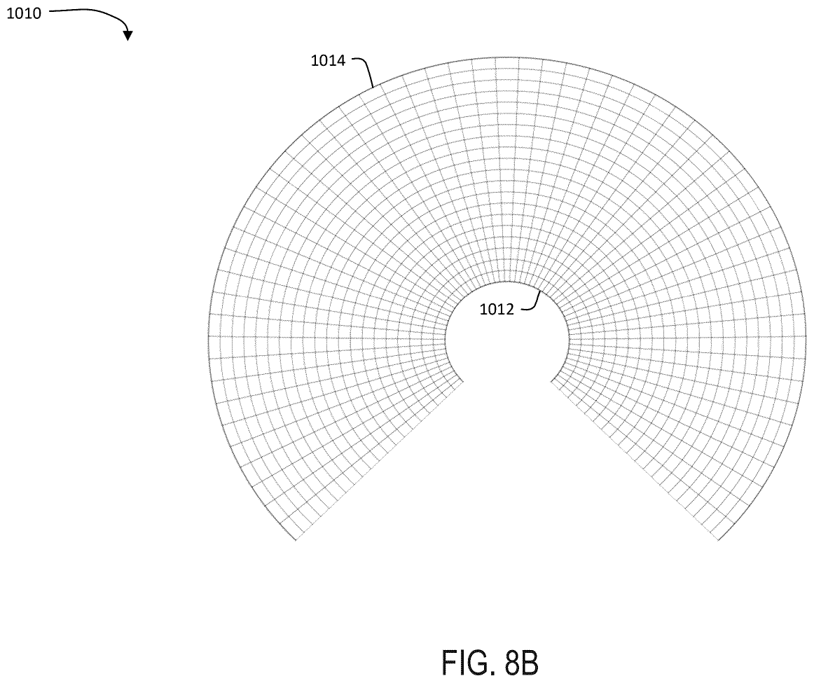

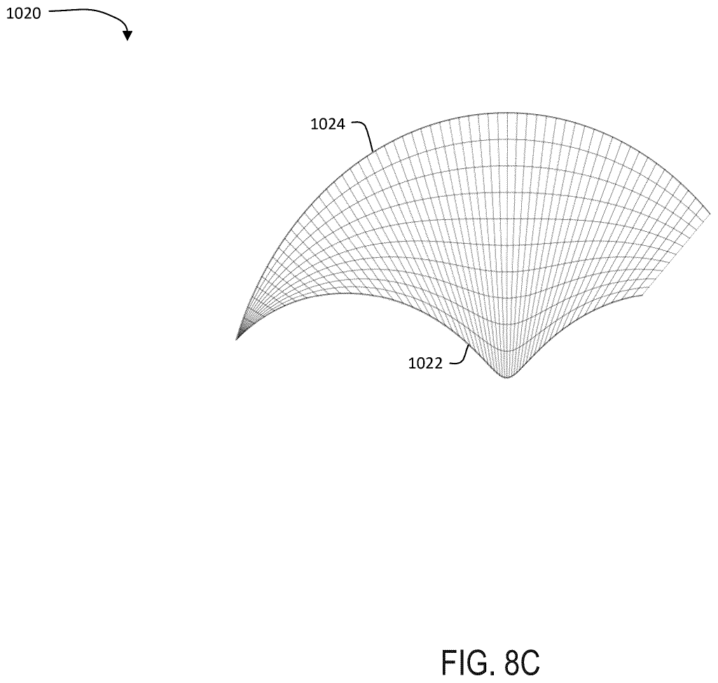

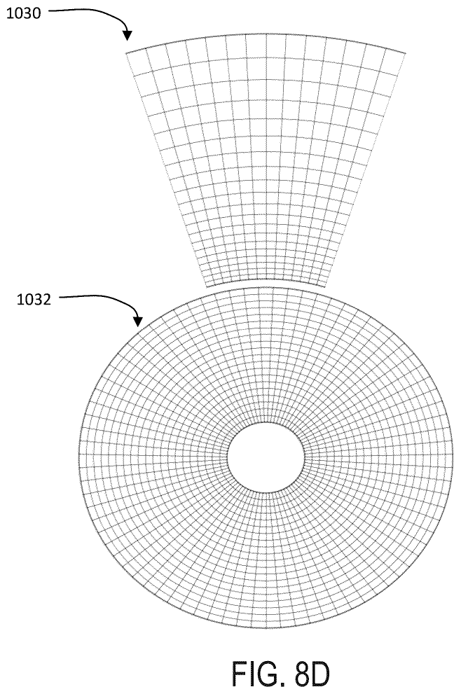

In the examples discussed above, the top view representation 408 covers an area that fully surrounds a vehicle. In such instances, as discussed above, the inner contour 412 lies within the outer contour 414. However, in further implementations, the top view representation 408 may not fully surround a vehicle. In such instances, the inner contour 412 may not surround the vehicle, and may not lie within the outer contour 414. For example, FIG. 8A depicts a top view representation 1002 that only covers a portion of the area surrounding a vehicle. In the top view representation 1002, the inner contour 1004 is not surrounded by the outer contour 1006. Instead, the contours 1004, 1006 are connected by rays that form the cells of the top view representation. Similarly, FIG. 8B depicts a top view representation 1010 in which the inner contour 1012 and the outer contour 1014 are connected by rays. In further implementations, the inner contour 412 and the outer contour 414 may directly connect. For example, FIG. 8C depicts a top view representation 1020 in which the inner contour 1022 directly connects with the outer contour 1024.

In still further implementations, the computing device 402 may be configured to determine more than one top view representation 408 based on received data. For example, different top view representations 408 may cover different portions of the area surrounding the vehicle and may be used by different machine learning models when determining vehicle instructions 420. As one example, FIG. 8D depicts two top view representations 1030, 1032, which may be determined for an area surrounding a vehicle. For example, the top view representation 1032 may be determined to provide full coverage near a vehicle, while the top view representation 1030 may provide additional coverage further away from the vehicle.

Notably, any of the examples discussed above in connection with FIGS. 8A-8D may be determined according to the techniques discussed above. For example, the inner contours, outer contours, or a combination thereof of the representations 1002, 1010, 1020, 1030, 1032 may have radii that vary with an angle relative to a heading of the vehicle.

In still further implementations, the top view representation 408 may include a three-dimensional representation of the area surrounding the vehicle. In such instances, cells of the top view representation may be implemented as three-dimensional voxels that span the three-dimensional top view representation 408. In such instances, the inner contour 412 and the outer contour 414 may define three-dimensional surfaces that define limits of the top view representation 408. In such instances, radii of the contour 412 and the outer contour 414 may differ relative to a heading of the vehicle and an elevation angle from the ground, and may be defined using series expansions.

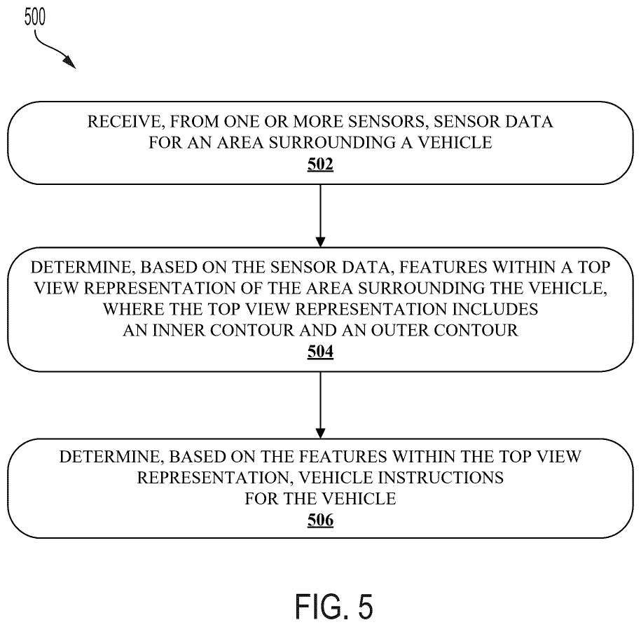

One method of performing one or more of the embodiments described above is shown in FIG. 5. FIG. 5 is a flow chart illustrating an example method for determining top view representations according to one or more aspects of the disclosure.

The method 500 includes receiving, from a plurality of sensors, sensor data for an area surrounding a vehicle (block 502). For example, the computing device 402 may receive, from a plurality of sensors 404, sensor data 406 for an area surrounding a vehicle.

The method 500 includes determining, based on the sensor data, features within a top view representation 408 of the area surrounding the vehicle (block 504). For example, the computing device 402 may determine, based on the sensor data 406, features 410 within a top view representation 408 of the area surrounding the vehicle. The top view representation 408 may include (i) an outer contour 414 that defines an outer limit of the top view representation 408 and (ii) an inner contour 412 positioned within the outer contour 414, the inner contour 412 defining an inner limit of the top view representation 408. In certain implementations, the inner contour 412 may define portion of the area surrounding the vehicle that may be within the outer contour 414 and for which features 410 are not determined. In certain implementations, the inner contour 412 may be defined to exclude a portion of the area that contains the vehicle from the top view representation 408. In certain implementations, the inner contour 412 may be centered at the location of the vehicle. In such instances, a radius of the inner contour 412 differs as a function of an angle relative to the heading of the vehicle. In certain implementations, the inner contour 412 may be defined based on an exterior contour 416 of the vehicle. In certain implementations, the inner contour 412 may be defined based on sensing capabilities 418 for at least a subset of the plurality of sensors 404. In certain implementations, the outer contour 414 may be determined based on sensing capabilities 418 of at least a subset of the plurality of sensors 404. In certain implementations, the outer contour 414 may be circular in shape with a radius determined based on sensing capabilities 418 for at least one of the plurality of sensors 404. In certain implementations, the inner contour 412 may be off-center relative to the outer contour 414. In certain implementations, the top view representation 408 comprises a plurality of cells, determining the features 410 comprises projecting the features 410 into corresponding cells. In certain implementations, resolution may vary with the angle (i.e., more pixels in the front)

The method 500 includes determining, based on the features within the top view representation, vehicle instructions for the vehicle (block 506). For example, the computing device 402 may determine, based on the features 410 within the top view representation 408, vehicle instructions 420 for the vehicle.

It is noted that one or more blocks (or operations) described with reference to FIG. 5 may be combined with one or more blocks (or operations) described with reference to another of the figures. For example, one or more blocks (or operations) of FIG. 5 may be combined with one or more blocks (or operations) of FIG. 1-3. As another example, one or more blocks associated with FIG. 5 may be combined with one or more blocks associated with FIG. 4.

In one or more aspects, techniques for supporting vehicular operations may include additional aspects, such as any single aspect or any combination of aspects described below or in connection with one or more other processes or devices described elsewhere herein.

A first aspect provides a method that includes receiving, from one or more sensors, sensor data for an area surrounding a vehicle; determining, based on the sensor data, features within a top view representation of the area surrounding the vehicle, which includes (i) an outer contour defining an outer limit of the top view representation and (ii) an inner contour positioned within the outer contour, the inner contour defining an inner limit of the top view representation; and determining, based on the features within the top view representation, vehicle instructions for the vehicle.

In a second aspect, in combination with the first aspect, the inner contour is defined to exclude a portion of the area that contains the vehicle from the top view representation.

In a third aspect, in combination with the second aspect, the inner contour is centered at the vehicle and the radius of the inner contour varies as a function of an angle relative to the vehicle.

In a fourth aspect, in combination with the third aspect, the inner contour is defined based on an exterior contour of the vehicle.

In a fifth aspect, in combination with one or more of the third aspect through the fourth aspect, the inner contour is defined based on sensing capabilities for at least a subset of the one or more sensors.

In a sixth aspect, in combination with one or more of the third aspect through the fifth aspect, the inner contour is defined based on an operating mode of the vehicle.

In a seventh aspect, in combination with one or more of the first aspect through the sixth aspect, the outer contour defines the limit of the area in which detected features are used to determine vehicle instructions for the vehicle.

In an eighth aspect, in combination with the seventh aspect, the radius of the outer contour varies as a function of an angle relative to the vehicle.

In a ninth aspect, in combination with one or more of the seventh aspect through the eighth aspect, the outer contour is determined based on sensing capabilities of at least a subset of the one or more sensors.

In a tenth aspect, in combination with the ninth aspect, the outer contour is circular in shape with a radius determined based on sensing capabilities for at least one of the one or more sensors.

In an eleventh aspect, in combination with one or more of the seventh aspect through the tenth aspect, the outer contour is defined based on an operating mode of the vehicle.

In a twelfth aspect, in combination with one or more of the first aspect through the eleventh aspect, the inner contour is off-center relative to the outer contour.

In a thirteenth aspect, in combination with one or more of the first aspect through the twelfth aspect, the top view representation includes a plurality of cells. Determining the features includes projecting the features into corresponding cells, and the cells are located between the inner contour and the outer contour.

In a fourteenth aspect, in combination with the thirteenth aspect, the cells are formed from curved rays, non-contiguous rays, or a combination thereof.

In a fifteenth aspect, in combination with one or more of the thirteenth aspect through the fourteenth aspect, the top view representation includes at least one region with a higher cell density.

A sixteenth aspect provides an apparatus that includes a memory storing processor-readable code and at least one processor coupled to the memory. The at least one processor may be configured to execute the processor-readable code to cause the at least one processor to perform operations, including receiving, from one or more sensors, sensor data for an area surrounding a vehicle; determining, based on the sensor data, features within a top view representation of the area surrounding the vehicle, which includes (i) an outer contour that defines an outer limit of the top view representation and (ii) an inner contour positioned within the outer contour, the inner contour defining an inner limit of the top view representation; and determining, based on the features within the top view representation, vehicle instructions for the vehicle.

In some implementations, the apparatus may include at least one processor, and a memory coupled to the processor. The processor may be configured to perform operations described herein with respect to the apparatus. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method of wireless communication may include one or more operations described herein with reference to the apparatus.

In a seventeenth aspect, in combination with the sixteenth aspect, the inner contour is centered at the vehicle, and the radius of the inner contour varies as a function of an angle relative to the vehicle.

In an eighteenth aspect, in combination with the sixteenth aspect, the radius of the outer contour varies as a function of an angle relative to the vehicle.

In a nineteenth aspect, in combination with one or more of the sixteenth aspect through the eighteenth aspect, the inner contour, the outer contour, or a combination thereof is determined based on sensing capabilities of at least a subset of the one or more sensors.

A twentieth aspect provides a non-transitory computer-readable medium storing instructions that, when executed by a processor, cause the processor to perform operations. The operations may include receiving, from a plurality of sensors, sensor data for an area surrounding a vehicle; determining, based on the sensor data, features within a top view representation of the area surrounding the vehicle, which includes (i) an outer contour that defines an outer limit of the top view representation and (ii) an inner contour positioned within the outer contour, the inner contour defining an inner limit of the top view representation; and determining, based on the features within the top view representation, vehicle instructions for the vehicle.

Components, the functional blocks, and the modules described herein with respect to FIGS. 1-4 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method comprising:
receiving, from one or more sensors, sensor data for an area surrounding a vehicle;
determining, based on the sensor data, features within a top view representation of the area surrounding the vehicle, wherein the top view representation comprises: (i) an outer contour that defines an outer limit of the top view representation and (ii) an inner contour positioned within the outer contour, the inner contour defining an inner limit of the top view representation; and
determining, based on the features within the top view representation, vehicle instructions for the vehicle.

2. The method of claim 1, wherein the inner contour is defined to exclude a portion of the area that contains the vehicle from the top view representation.

3. The method of claim 2, wherein the inner contour is centered at the vehicle, and wherein a radius of the inner contour varies as a function of an angle relative to the vehicle.

4. The method of claim 3, wherein the inner contour is defined based on an exterior contour of the vehicle.

5. The method of claim 3, wherein the inner contour is defined based on sensing capabilities for at least a subset of the one or more sensors.

6. The method of claim 3, wherein the inner contour is defined based on an operating mode of the vehicle.

7. The method of claim 1, wherein the outer contour defines a limit of the area in which detected features are used to determine vehicle instructions for the vehicle.

8. The method of claim 7, wherein a radius of the outer contour varies as a function of an angle relative to the vehicle.

9. The method of claim 7, wherein the outer contour is determined based on sensing capabilities of at least a subset of the one or more sensors.

10. The method of claim 9, wherein the outer contour is circular in shape with a radius determined based on sensing capabilities for at least one of the one or more sensors.

11. The method of claim 7, wherein the outer contour is defined based on an operating mode of the vehicle.

12. The method of claim 1, wherein the inner contour is off-center relative to the outer contour.

13. The method of claim 1, wherein the top view representation comprises a plurality of cells, wherein determining the features comprises projecting the features into corresponding cells, and wherein the cells are located between the inner contour and the outer contour.

14. The method of claim 13, wherein the cells are formed from curved rays, non-contiguous rays, or a combination thereof.

15. The method of claim 13, wherein the top view representation includes at least one region with a higher cell density.

16. An apparatus, comprising:
a memory storing processor-readable code; and
at least one processor coupled to the memory, the at least one processor configured to execute the processor-readable code to cause the at least one processor to perform operations including:
receiving, from one or more sensors, sensor data for an area surrounding a vehicle;
determining, based on the sensor data, features within a top view representation of the area surrounding the vehicle, wherein the top view representation comprises: (i) an outer contour that defines an outer limit of the top view representation and (ii) an inner contour positioned within the outer contour, the inner contour defining an inner limit of the top view representation; and
determining, based on the features within the top view representation, vehicle instructions for the vehicle.

17. The apparatus of claim 16, wherein the inner contour is centered at the vehicle, and wherein a radius of the inner contour varies as a function of an angle relative to the vehicle.

18. The apparatus of claim 16, wherein a radius of the outer contour varies as a function of an angle relative to the vehicle.

19. The apparatus of claim 16, wherein the inner contour, the outer contour, or a combination thereof is determined based on sensing capabilities of at least a subset of the one or more sensors.

20. A non-transitory computer-readable medium storing instructions that, when executed by a processor, cause the processor to perform operations comprising:
receiving, from a plurality of sensors, sensor data for an area surrounding a vehicle;
determining, based on the sensor data, features within a top view representation of the area surrounding the vehicle, wherein the top view representation comprises: (i) an outer contour that defines an outer limit of the top view representation and (ii) an inner contour positioned within the outer contour, the inner contour defining an inner limit of the top view representation; and
determining, based on the features within the top view representation, vehicle instructions for the vehicle.
